(19) United States
(12) Patent Application Publication
(10) Pub. No.: US 2007/0244632 A1
(43) Pub. Date: Oct. 18, 2007

(54) Method for Storing, in a Navigation System, Map Data that Represent Traffic Path Segments, and Navigation System

(76) Inventors: Guido Mueller, Quedlinburg (DE); Ulrich Kersken, Diekholzen (DE)

Correspondence Address: KENYON & KENYON LLP, ONE BROADWAY, NEW YORK, NY, 10004, US

(21) Appl. No.: 10/590,643

(22) PCT Filed: Jan. 14, 2005
(86) PCT No.: PCT/EP05/50146

§ 371 Date: Jun. 8, 2007

(30) Foreign Application Priority Data
Feb. 27, 2004 (DE) 10 2004 009 463.2

(51) Int. Cl. G01C 21/34

(52) U.S. Cl. 701/202

(57) ABSTRACT

A method for storing, in a navigation system, map data that represent traffic path segments, in particular for motor vehicles, is provided such that only map data within a corridor around a driving route are deposited in a memory of the navigation system. The map data within the corridor are selected before storage in the navigation system. In this manner, the method according to the present invention enables an enlarged geographical region (corridor) around a calculated driving route to be covered by the map data kept on hand in the device memory.

### FIELD OF THE INVENTION

The present invention relates to a method for storing, in a navigation system, map data that represent traffic path segments, as well as a navigation system.

### BACKGROUND INFORMATION

Vehicle navigation systems calculate driving routes from a starting location or vehicle location to a destination defined by a user, based on map data that represent traffic path segments. The map data are usually stored on mass storage media, such as CD or DVD, and for calculation of the driving route are usually copied, at least in excerpts, into a memory of the navigation system. In order to give the vehicle driver destination guidance instructions to guide him to the destination even in the event of a deviation from a calculated driving route, a recalculation of the driving route from the current vehicle location (after the deviation from the driving route) to the destination is often necessary. Those data must then be read in again from the mass storage medium into the device's memory.

Vehicle navigation systems also exist, however, which simultaneously possess the capability of playing back an audio CD or DVD, the same drive as for the navigation data medium being used for the purpose. After completion of a driving route calculation, the mass storage medium can be removed from the drive and an audio CD or DVD can be inserted in its place and played back. In order to make possible, even in such devices, the recalculation of a driving route after a departure from the original driving route, map data for the entire destination-guidance period are kept on hand in such devices. Because of the complexity of the data and a limited memory capacity, a corridor around the driving route is defined for this purpose, and only those map data located within the corridor around the driving route are kept on hand.

In terms of defining the extent of the corridor, a conflict of purposes exists: reloading of map data (and CD or DVD changing associated therewith) should be avoided if possible for the entire driving route, or should be minimized to the extent possible; on the other hand, the corridor also needs to have a minimum width so that a driving route calculation based on the map data kept on hand in the memory remains possible at any time if the precalculated driving route is departed from.

### SUMMARY

The method according to the present invention and a correspondingly embodied navigation system have the advantage that an enlarged geographic region (corridor) around a calculated driving route is covered by the map data kept on hand in the device memory.

This is achieved, according to the present invention, in that the map data within the corridor are selected, i.e., thinned out, before they are stored in the device memory, and only the thinned-out map data are stored.

Advantageously, the selection of the map data is accomplished on the basis of a utilization probability, for the case of a deviation from the driving route, of the traffic path segments located in the corridor.

Advantageously, the utilization probability is a function of the distance of a particular traffic path segment from the driving route.

Advantageously, the utilization probability is a function of a road class of a particular traffic path segment located in the corridor.

Advantageously, a first defined region around the destination of the driving route and/or a second defined region around the starting location of the driving route are exempted from the map data selection.

Advantageously, the map data are managed in tiles of a defined areal extent, and the selection is accomplished for all map data within each tile in accordance with a uniform selection criterion. This makes possible a particularly simple and efficient execution of the method for creating the corridor.

### BRIEF DESCRIPTION OF THE DRAWINGS

FIGS. 1A, 1B, and 1C show first, second, and third corridor geometries as provided in conventional vehicle navigation systems.

FIG. 2 is a diagram illustrating the probability that a traffic path segment in the area around the precalculated driving route is taken into account after a deviation from the precalculated driving route in a recalculation of the driving route, as a function of its distance from the precalculated route.

FIG. 3 is a further diagram illustrating the probability that a traffic path segment in the area around the precalculated driving route is taken into account after a deviation from the precalculated driving route in a recalculation of the driving route, as a function of its distance from the precalculated driving route, with the additional parameter of the road class of the traffic path segment under consideration.

FIG. 4 is a further diagram in which the distribution of the number or total length of the traffic path segments is plotted, separately according to road class.

FIG. 5 is a block diagram of a portion of a navigation system according to the present invention.

FIG. 6 is a first flow chart of an example method according to the present invention.

FIGS. 7A and 7B show a second flow chart of an example method according to the present invention.

FIG. 8 schematically depicts the corridor that results from application of an example method according to the present invention.

FIG. 9 schematically depicts an alternative corridor that results from application of an example method according to the present invention.

### DETAILED DESCRIPTION

Vehicle navigation systems calculate driving routes from a starting location or vehicle location to a destination defined by a user, based on map data that represent traffic path segments, and after completion of the driving route calculation lead the user by way of destination guidance instructions, e.g., turn instructions, along the calculated driving route to the destination. A fundamental assumption is that the user follows the destination guidance instructions of the vehicle navigation system, and deviates from the calculated driving route only in exceptional cases. Such a deviation can be the consequence of an oversight by the vehicle driver, or can also be a deliberate departure from the driving route for the purpose of, for example, getting around a traffic jam. In these cases at least one local alternative route must be determined starting from the current vehicle location, which is now no longer located on the precalculated driving route.

Based on these assumptions, it can be stated, as depicted in the graph of FIG. 2, that
the road map data describing the driving route are used with the greatest probability during destination guidance; and
the probability NW of using other road map data that identify route segments outside the calculated driving route decreases with increasing distance of the route segments from the calculated driving route.

In a simple case, the geographical distance can be used. In addition to simple beeline distance, however, the interlinking of the road segments can also serve as a distance criterion. In this case, the distance criterion would be determined by the smallest accumulated length or driving time of the road segments between the route segment in question and the route of travel. The utilization probability thus approaches zero for poorly accessible roads despite physical proximity, and would equal zero for isolated road segments.

In the map data, the various roads or traffic path segments are, or become, attributed differently in accordance with their importance, and this is taken into account in calculating a driving route.

The properties of road segments, for example a tunnel or ferry, or also digitization state, for example completely or only partly surveyed, can thus be imaged. A property of road segments to be taken into account is their classification, in accordance with the exemplifying sequence below from lowest to highest class.

| | |
|---|---|
| 1) | Class C1 - dead-end street |
| 2) | Class C2 - residential street |
| 3) | Class C3 - local feeder road |
| 4) | Class C4 - local through road |
| 5) | Class C5 - regional highway |
| 6) | Class C6 - state highway |
| 7) | Class C7 - federal highway |
| 8) | Class C8 - expressway |

A different classification is conceivable and possible.

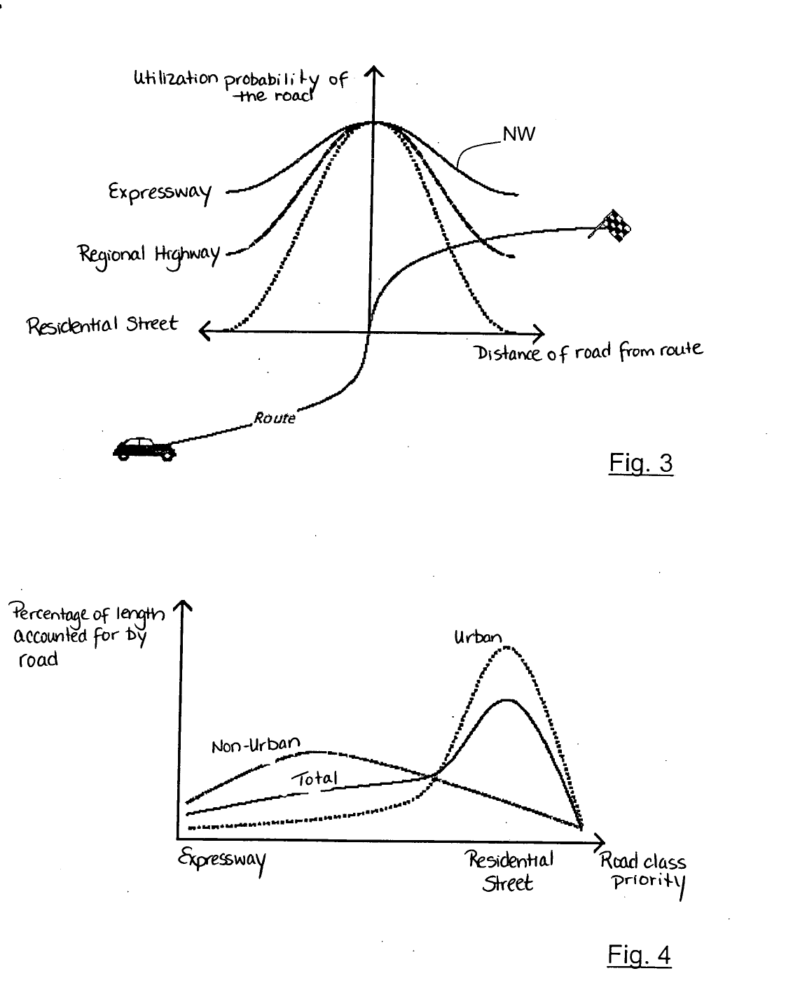

In calculating the travel route, it may be preferred to take into account route segments or road segments having a high classification, i.e., expressways, federal highways, etc., rather than residential streets, local feeder roads, etc., especially if the driving route is being calculated with the optimization criterion of a fastest or most effective driving route. These considerations may also apply to long-distance routes. The result is the utilization probability NW for a specific road segment depicted in FIG. 3, firstly as a function of the distance of the road segment from the calculated travel route, and secondly as a function of the road class of the road segment.

This correlation applies both to an initial driving route calculation and to a recalculation after a deviation from the calculated driving route as a consequence of inattention by the vehicle driver or in conjunction with a dynamization function, i.e., a detour route calculation in order to bypass a traffic jam, which can be triggered automatically in the navigation system by way of digitally coded traffic alert messages transmitted via broadcast radio or a mobile radio device.

FIG. 4 shows a typical distribution of road length by road class for a digitized map data set, using the example of a road map for Germany. It is evident from this depiction that roads that are primarily important for a driving route calculation, i.e., expressways, federal highways, or state highways, make up a relatively small proportion of the total map data. Map data representing residential streets or, in general, lower-class roads, which are relevant principally within cities and towns, predominate over higher-class roads.

Since, however, these specific roads are of interest with high probability for route calculation only in the immediate vicinity of the current vehicle position and close to the destination, an obvious choice is to thin, i.e., screen them out. Because of their large representation within the total volume of the map data, and low importance for route expression, a relatively large benefit is obtained by thinning them out, without thereby appreciably limiting navigation functionality.

The considerations just presented constitute the basis for the selection according to the present invention, or for thinning out road map data or map data representing general traffic path segments.

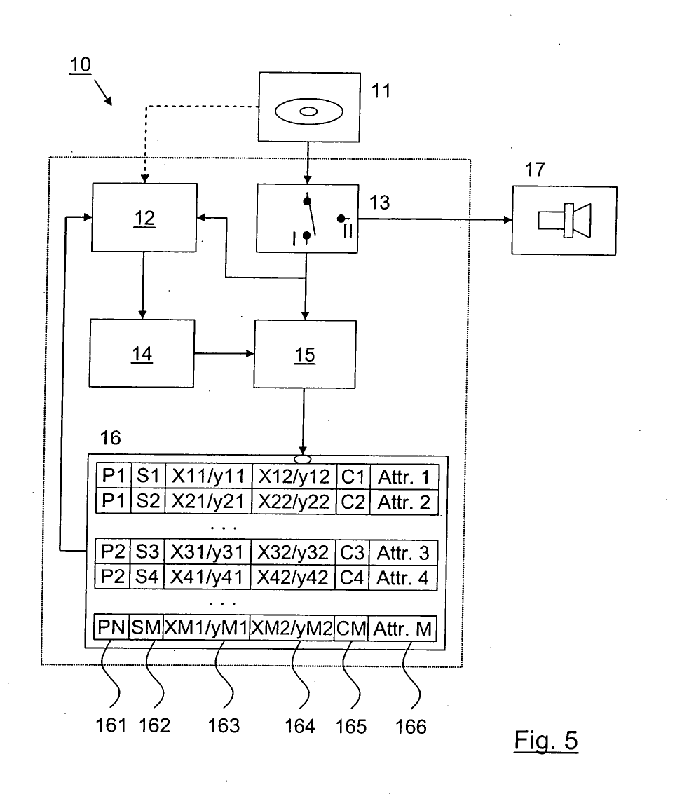

FIG. 5 is a block diagram of a portion of a navigation system 10 according to the present invention for carrying out the method according to the present invention. This diagram is explained in more detail below using the example of a vehicle navigation system.

Navigation system 10 is embodied substantially in the form of a computer having peripheral devices connected thereto. The functions explained below are embodied to a very large extent in the form of software modules of an operating program of navigation system 10. The peripheral devices that are essential in conjunction with the present invention are a reading device 11 for a mass storage medium such as a CD or DVD. This is needed in order to load map data, stored on the aforesaid mass storage media and representing traffic route segments, into a working memory (not depicted) of the navigation system for the purpose of calculating a driving route. Driving route calculation is accomplished in a software module 12; the calculated driving route is stored in a route memory 14 of the vehicle navigation system. The navigation system further possesses an output apparatus 17 by way of which destination guidance instructions, for example in the form of spoken turn instructions, are outputted in order to direct the vehicle driver along a calculated driving route.

The CD or DVD drive is also intended to be embodied for reading audio or video CDs or DVDs. Provided for this purpose is a changeover switch 13 that conveys the data read from the mass memory selectably to the route calculation system (or more generally to the navigation software) or to an audio and/or video output 17. Output apparatus 17 thus also serves for output of an entertainment program 10 read from an entertainment medium (CD or DVD).

Navigation system 10 according to the present invention is embodied in such a way that once driving route calculation 12 is complete, the navigation CD or DVD can be removed from the drive and an audio or video CD or DVD can instead be played back. In order to enable destination guidance even after a deviation of the vehicle's location from the precalculated driving route, with no need to reinsert the navigation data medium into drive 11, navigation system 10 further possesses a map data memory 16 into which, once driving route calculation 12 is complete, map data for traffic route segments located in a defined vicinity of the driving route are loaded. This defined vicinity around the driving route is referred to hereinafter as a corridor.

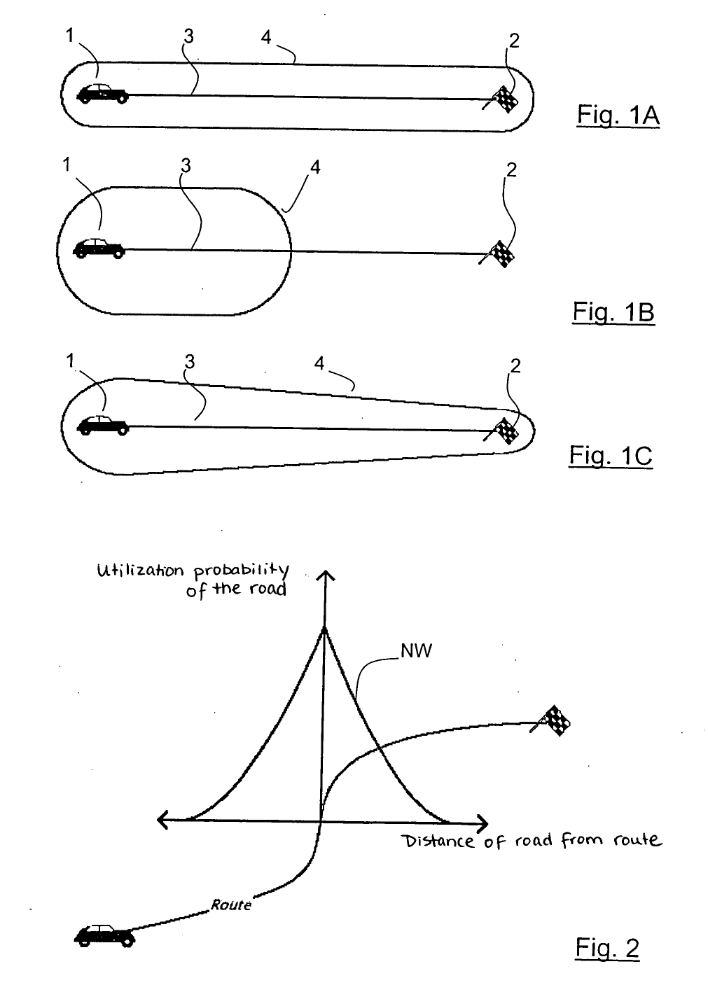

FIGS. 1A, 1B, and 1C show different corridor geometries that result from the limited memory space and the navigation data complexity according to the existing art. Reference character 1 identifies the vehicle's location or starting point, 2 the destination inputted by the user, 3 the driving route calculated by the navigation system, and 4 the corridor for which map data are deposited in the map data memory of the device.

The properties of the map data that are significant in conjunction with the present invention are as follows. The map data (as shown in FIG. 5) encompass, as the most essential elements, route segments, i.e., traffic route segments or road segments, S1, S2, S3, S4, . . ., SM (col. 162), each having an initial and a final coordinate x11/y11 and x12/y12 etc. (cols. 162 and 163), as well as an allocation (C1, C2, . . ., CM) to a road class, e.g., expressway, state highway, etc. Also, usually allocated to the road segments are further attributes Attr. 1, . . ., Attr. M, for example maximum permissible speeds or through-traffic prohibitions, etc., on the basis of which the route calculation is performed in terms of an optimization criterion such as fastest or shortest route, etc. In addition, the map data are usually divided into partitions, also called tiles, whereby one tile encompasses all the route segments in a defined geographic area. A tile of this kind is thus approximately comparable to a grid square. In the present case, memory 16 (FIG. 5) is sorted according to partitions P1, . . ., Pn and, as the next-lower criterion, a number S1, . . ., SM of the route segments. The organization of the map data into tiles, like the sorting of the map data memory 16 according to tiles, is not compulsory, however, and also not critical for the present invention. In particular, the method procedure described later for storing map data in map data memory 16 of the navigation system is also not necessarily limited to an organization of the map data into partitions.

Additionally provided according to the present invention in the previously described combination device 10 made up of a navigation and entertainment device, hereinafter called for simplicity a navigation system, is a thinning-out or selection module 15 that thins out the information to be deposited in map data memory 16, i.e., selects it according to defined criteria. Only the thinned-out map data are written into the map data memory of device 10. The result of this is a decreased data density for the map data to be written into the map data memory, so that the area covered by the stored map data, i.e., the extent of the corridor, can be enlarged as compared with the existing art for an identical capacity of map data memory 16.

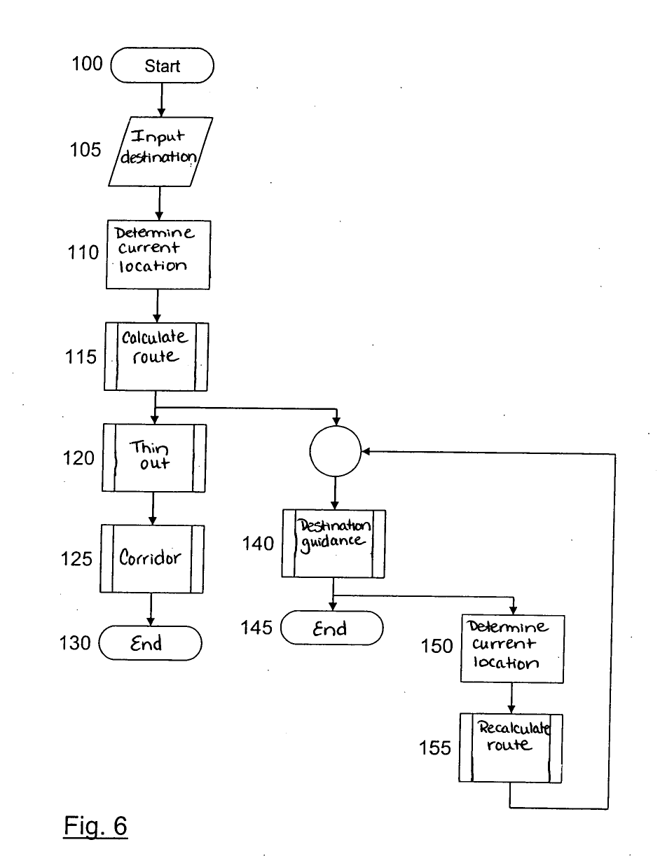

The navigation system according to the present invention functions as follows (FIG. 6). The procedure begins with step 100, with activation of navigation system 10. After input of a destination for route calculation (step 105) and determination of the current vehicle location as the starting location, for example by GPS satellite location (step 110), a driving route calculation (step 115) is performed in route calculation module 12, the resulting driving route 3 being deposited in a driving route memory 14 of navigation device 10. Subsequent to the route calculation, destination guidance (step 140) is performed by outputting destination guidance information to the vehicle driver, e.g., in the form of spoken driving direction instructions. This ends when the destination is reached (step 145). If the vehicle driver departs from the precalculated route, for example, due to inattention because he failed to follow a driving direction instruction, or deliberately deviated in order to get around a traffic jam, the current vehicle location is then determined again (step 150). This is followed by a new driving route calculation (step 155), this being accomplished on the basis of the map data stored in map data memory 16 of navigation system 10 according to the present invention. The recalculated driving route is deposited in route memory 14, and destination guidance (step 140) is then continued using the recalculated driving route.

As soon as the driving route is calculated, the thinning-out (step 120) according to the present invention of the map data begins, as well as storage of the thinned-out map data in map data memory 16; those stored map data then define the corridor within which the navigation system can calculate a route without reinsertion of the navigation CD or DVD. The procedure ends, after the thinning-out and storage of the thinned-out map data, with step 130. As already stated, any recalculation of the driving route that may be necessary is accomplished with access to the thinned-out map data of corridor 4 deposited in map data memory 16.

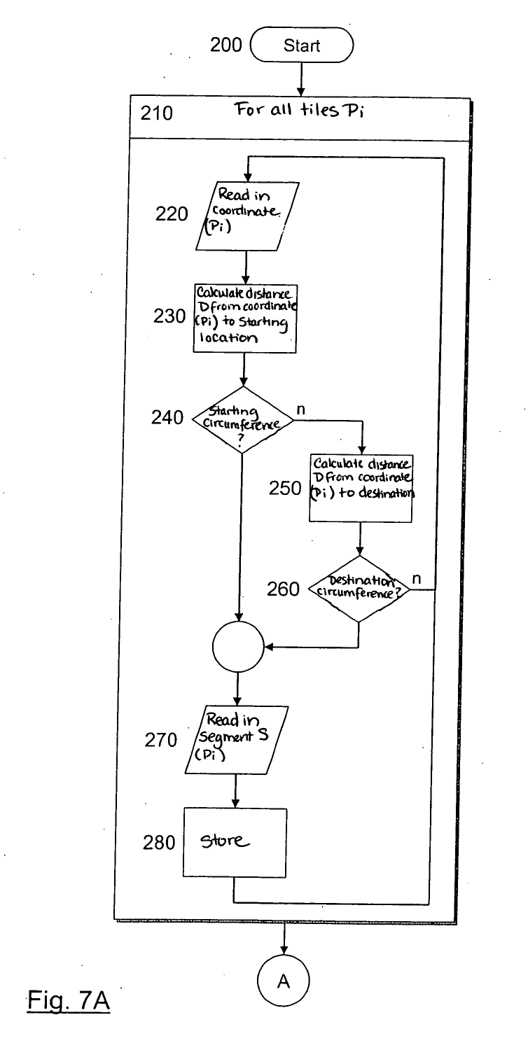

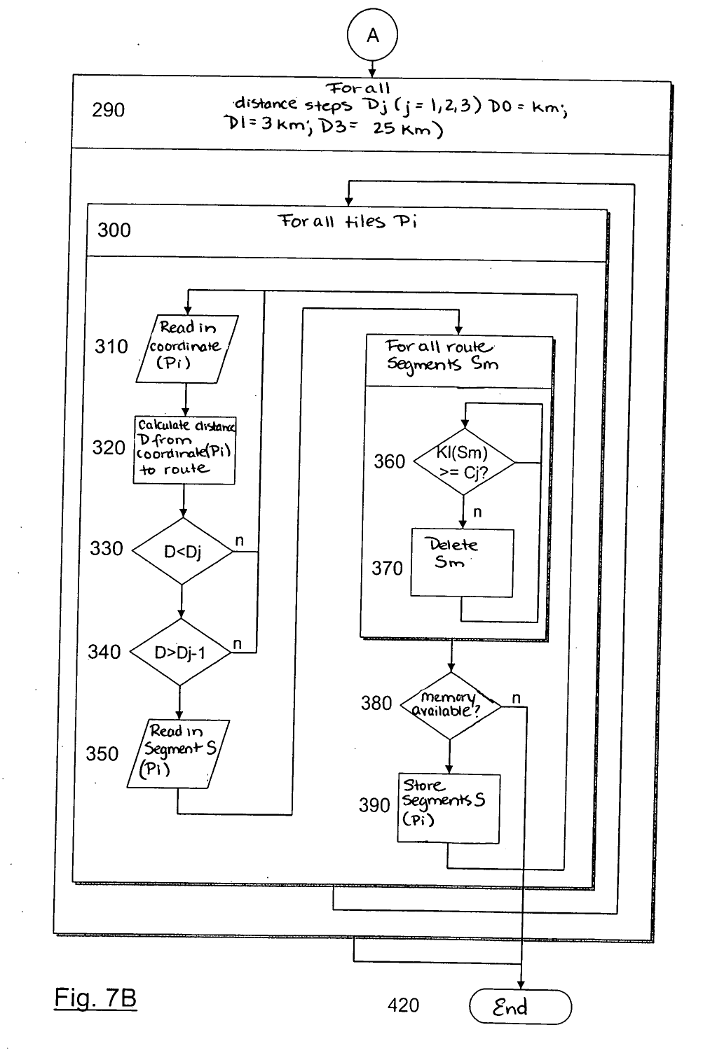

Selection of the map data and storage of the selected map data are described below, using an example embodiment according to the flow chart of FIG. 7.

The basic procedure is that those tiles located close to the calculated driving route 3 are less severely thinned out than those located farther away from the calculated driving route 3. Tiles that are located within a defined circumference around the starting location 1 or destination 2 are not thinned out; the starting location and destination are often located on residential streets or dead-end streets, so that in the vicinity of the starting location or destination, even these lowest road classes are required with a certain probability for a driving route calculation.

The procedure begins with the end of the route calculation according to step 115 in FIG. 6, with step 200 (FIG. 7A), and proceeds in detail as follows:

Step 1: For all the tiles, a check is made as to whether they are located within a defined circumference around the starting location or destination. For all tiles that meet this criterion, all the map data (without thinning-out) are copied into map data memory 16 of the vehicle navigation system.

For this, the following method steps 220 to 280 are repeated for all available map partitions or tiles Pi (step 210). Firstly, the coordinates of a tile Pi currently being considered are read in from the mass storage medium, i.e., the navigation CD or DVD 11 (step 220). The coordinates of tile Pi can be, for example, its center-point coordinates, but alternatively also its edge coordinates. Then the distance D of tile Pi from starting location 1 is calculated (step 230) and then checked as to whether partition Pi is, on that basis, located within a defined circumference of, for example, here 5 km around the starting location (step 240). If such is not the case, the distance of partition Pi from destination 2 is calculated analogously (step 250), and a check is made as to whether tile Pi is located within a defined circumference of, for example, 5 km around the destination (step 260). If such is not the case, the procedure is continued with the next tile Pi+1. If, on the other hand, partition Pi is located within the circumference around the starting location or the destination, the route segment data S(Pi) pertinent to it are read from the navigation CD or DVD (step 270) and written into map data memory 16 of navigation system 10 (step 280). Steps 220 to 280 just presented are then continued with the next map partition Pi+1. Step 210 terminates when all the tiles Pi of the map have been examined in this fashion.

According to an advantageous example embodiment of the invention, however, steps 220 to 280 can also be confined to a map portion that has also already been selected, for example, for route calculation in step 115 (FIG. 6).

Step 2: For all tiles that are not located within the defined circumference around the starting location or destination, a check is made as to whether they are located within a defined first distance from the driving route. A good value for the first distance is, for example, on the order of 3 km. Instead of a first distance that is predefined, however, it can also be calculated, for example, as a function of the total length of the driving route, such that it becomes smaller as the total length increases.

For all tiles that meet this criterion, the map data of each tile are subjected to a thinning-out, beginning with the tiles located closest to the starting location and in order of increasing distance from the starting location. In this, all those map data that represent route segments having a road class below a minimum road class are removed from the map data of each tile. The selection of route segments by road class that results therefrom yields a thinned-out tile. The minimum road class is, for example, the local feeder road, i.e., all dead-end streets and residential streets are eliminated from the map data. The road map data thinned out in this fashion are then stored, tile by tile, in the map data memory of the vehicle navigation system.

For this, the method steps 310 to 390 explained below (see FIG. 7B) are repeated for all available map partitions or tiles Pi (starting at step 300).

Firstly, the coordinates of a tile Pi currently being considered are read in from the mass storage medium, i.e., the navigation CD or DVD 11 (step 310). The distance D of tile Pi from the previously calculated driving route 3 is then determined (step 320) and checked as to whether on that basis, partition Pi is located within a first defined distance Dj (of, in this case, D1=3 km) from driving route 3 (step 330). If such is not the case, the procedure continues with the next partition Pi. If, on the other hand, the partition under consideration is located within the first defined distance D1, a further check is made as to whether the partition is located outside the next shorter defined distance Dj−1 (i.e. here D0=0 km) (step 340). In the case of the first pass through steps 300 to 390, this second examination is meaningless, but perhaps not in the context of later subsequent passes in conjunction with third and fourth (and optionally further) steps of the method. If the center-point coordinates of the tiles are used instead of the edge coordinates located closest to the route, comparison value Dj must be equipped in each case with an additional offset equal to the spacing between the center-point coordinate of tile Pi and that of the edge facing toward the route. If the tile is not located in the corridor Dj−1 and D1 under consideration, the procedure is continued with step 310 for the next tile Pi+1. If, on the other hand, tile Pi is located in a distance range of Dj−1 and Dj from the calculated driving route 3, the route segment data S(Pi) of tile Pi in question are read from the map-data CD or DVD.

Steps 360 and 370 are then performed for all route segments Sm of the current map partition Pi (step 355). Firstly, the road class of a route segment Sm currently under consideration is compared with a minimum road class Cj valid for that route segment. If the road class of the current route segment Sm is lower than the minimum road class (here C1=local feeder road), the route segment is deleted from the map data temporarily stored in navigation system 10. Steps 360 and 370 are then repeated for all further route segments Sm+1, Sm+2, etc. of the current map partition Pi. The same also applies if it is determined in step 360 that the road class of the current route segment is equal to or greater than the current minimum road class.

Once all the route segments of the current partition Pi have been checked in step 355, step 380 checks whether sufficient free memory space is still available in map data memory 16 of device 10 to store the map data thinned out in accordance with step 355. If such is not the case, the thinning-out procedure ends at step 420. Corridor 4 is defined by the route segment data deposited up to that point in the map data memory. If, on the other hand, sufficient memory space is still available in map data memory 16 to store route segment data Sm, the thinned-out map data Sm of partition Pi are stored in map data memory 16 of navigation device 10.

The procedure described then continues with the next partition Pi+1.

According to an advantageous example embodiment of the invention, however, step 300 encompassing steps 310 to 390 can also be limited to a map portion that has also already been selected, for example, for route calculation in step 115 (FIG. 6).

Step 3: For all tiles that are not located within the defined circumference around the starting location or destination and are not located within the defined first distance from the driving route, a check is made as to whether they are located within a defined second distance from the driving route. A good value for the second distance is, for example, 10 km. Here again, instead of a fixed value, the second distance can be determined and defined as a function of the total route length.

For all tiles that meet this criterion, the map data of each tile are subjected to a thinning-out, beginning with the tiles located closest to the starting location and in order of increasing distance from the starting location. In this, all those map data that represent route segments having a road class below a second minimum road class are removed from the map data of each tile. The second minimum road class is, for example, the regional highway, i.e. all map data that represent roads below the regional highway class—i.e. in the present example, dead-end streets, residential streets, local feeder roads, and local through roads—are deleted from the map data of each tile considered, and the map data thinned out in this fashion are then stored, tile by tile, in the map data memory of the vehicle navigation system.

For this, method step 300 encompassing method steps 310 to 390 (FIG. 7B) is repeated as described above for all available map partitions or tiles Pi, but with the difference that now the next distance criterion Dj of D2=10 km, as well as the minimum road class Cj of C2=regional highway, are used.

The result of the check in step 340 is that in this step, only those map partitions Pi that have not already been thinned out are subjected to a thinning-out operation. For that purpose, a check is made here as to whether tiles Pi currently being considered are located outside the corridor already considered previously.

The result of the repeat execution of step 300 is that all partitions located within a distance range of between 3 and 10 km from the calculated route are thinned out. For these, all roads below regional highways are deleted from the map data and thinned out map data is deposited in the map data memory, provided sufficient free memory space is still available therein.

Step 4: For all tiles that are not located within the defined circumference around the starting location or destination, furthermore are not located within the defined first distance from the driving route, and also are not located within the defined second distance from the driving route, a check is made as to whether they are located within a defined third distance from the driving route. A good value for the third distance is, for example, 25 km. Here again, instead of a fixed value, the third distance can be determined and defined, for example, as a function of the total route length.

For all tiles that meet this criterion, the map data of each tile are subjected to a thinning-out, beginning with the tiles located closest to the starting location and in order of increasing distance from the starting location. In this, all those map data that represent route segments having a road class below a third minimum road class are removed from the map data of each tile. The third minimum road class is, for example, the federal highway, i.e. map data that represent roads below the federal highway class—i.e. in the present example, dead-end streets, residential streets, local feeder roads, local through roads, regional highways, and state highways—are deleted from the map data of each tile being considered, and the map data thinned out in that fashion are then stored, tile by tile, in the map data memory of the vehicle navigation system.

The procedure is aborted in the course of any of the steps described above as soon as the capacity of the map data memory is exhausted by the map data stored up to that point in time.

For this, method step 300 encompassing method steps 310 to 390 (FIG. 7B) is repeated as described above for all available map partitions or tiles Pi, but with the difference that now the next distance criterion Dj of D3=10 km, as well as the minimum road class Cj of C3=federal highway, are used.

The procedure can be continued even further beyond the fourth step with a fourth and, if applicable, further distance criterion, provided the memory capacity of map data memory 16 has not already been exhausted by the map data already stored in the course of the previous steps.

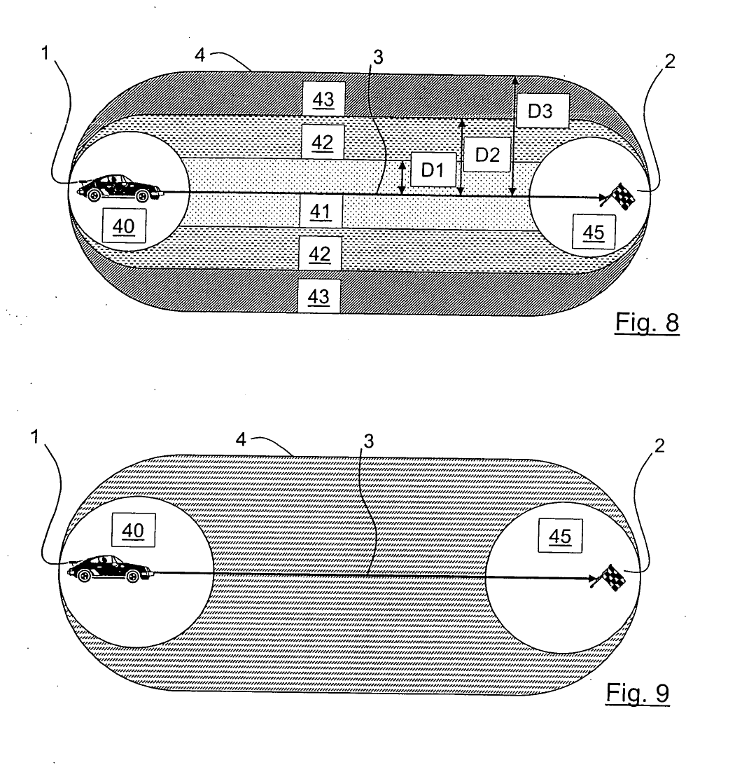

What is obtained as a result of the method described is the corridor depicted in FIG. 8.

In FIG. 8, 1 designates the vehicle location at the beginning of the first driving route calculation, i.e. the starting location; 2 the destination; and 3 the calculated driving route. As a consequence of the procedure described, corridor 4 is obtained, within which map data are stored in map data memory 16 of navigation system 10.

Complete map data (i.e. not thinned out) exist for circumferences 40 and 45 around starting location 1 and destination 2. Map data also exist for a second sub-corridor 41 that extends from the immediate vicinity of driving route 3 out to a distance D1=3 km from the driving route, but all roads below the local feeder road have been eliminated from them. For a third sub-corridor 42 that extends in a distance range from D1=3 km to D2=10 km from driving route 3, additionally thinned-out map data exist, from which the road classes of local feeder road and local through road have also been eliminated, i.e. map data exist only for roads above regional highways. In a fourth sub-corridor at the distance range D2=10 km to D3=25 km from the calculated driving route 3, even further thinned-out road map data exist, referring only to federal highways or expressways.

The method thus results in an increasing thinning-out of road map data as the distance of the relevant route segments from the driving route increases. The effect of this increasing thinning-out of the map data stored in navigation system 10 is that even in the event of a deviation from the driving route, a new driving route calculation can be performed with no need to read map data again, for that purpose, from the navigation data medium. It is thus possible, for example, once initial route calculation is complete, to continue playing back an audio CD inserted into reading device 11.

In a departure from the description above, the structure of the corridor can also be based on interlinking information about the route segments of the calculated driving route. In this instance, for example in the case of an expressway segment as part of driving route 3, a corridor would also be created around a further expressway segment linked to the expressway segment and having a length that is based, for example, on the location of the closest exit. This ensures that the vehicle driver, after turning inadvertently onto an expressway that is not part of driving route 3, can also be guided back to the original driving route, since corridor 4 created in the manner described allows calculation of the fastest possible return route.

FIG. 9 likewise shows a variant corridor 4 in which the same degree of thinning-out was selected within the entire corridor. Here, for example—with the exception of the starting location and destination, within whose surrounding circumference all the map data, i.e. including residential streets, etc., are present—all urban streets (provided they are not simultaneously regional, state, or federal highways) have been removed from the map data. This configuration of the corridor also represents a realistic embodiment of the invention, since specifically in the case of a long-distance route, urban streets outside the starting and destination areas have, simply because of their usually comparatively high route resistance, a very low probability NW of being incorporated into a detour route calculation.

A plurality of thinning-out strategies, which are not definitively enumerated here but nevertheless also fall within the scope of the invention, are thus possible in combination with the present invention.

Regardless of the particular examples of the thinning-out method, the effect of the present invention is that for an identically designed capacity of map data memory 16, a corridor 4 has a considerably larger extent in space as compared with the existing art; and as a consequence of the above considerations of the utilization probabilities of certain road classes in a driving route recalculation, in a greatly predominant number of cases the thinning-out has no negative effects (or, if any, at least not serious ones) on the calculation of the driving route.

FIG. 2
Nutzungswahrscheinlichkeit . . . =Utilization probability of the road
Entfernung . . . =Distance of road from route

FIG. 3
Nutzungswahrscheinlichkeit . . . =Utilization probability of the road
Autobahn=Expressway
Kreisstraβe=Regional highway
Wohnstraβe=Residential street
Entfernung=Distance of road from route

FIG. 4
prozentualer . . . =Percentage of length accounted for by road class
innerorts=Urban
auβgerorts=Non-urban
gesamt=Total
Autobahn=Expressway
Wohnstraβe=Residential street
Priorität=Road class priority

FIG. 6
105 Input destination
110 Determine current location
115 Calculate route
120 Thin out
125 Corridor
130 End
140 Destination guidance
145 End
150 Determine current location
155 Recalculate route

FIG. 7A
210 For all tiles Pi
220 Read in coordinate(Pi)
230 Calculate distance D from coordinate(Pi) to starting location
240 Starting circumference?
250 Calculate distance D from coordinate(Pi) to destination
260 Destination circumference?
270 Read in segment S(Pi)
280Store

FIG. 7B
290 For all distance steps Dj (j=1, 2, 3) (D0=0 km; D1=3 km; D3=25 km)
300 For all tiles Pi
310 Read in coordinate(Pi)
320 Calculate distance D from coordinate(Pi) to route
350 Read in segment S(Pi)
Für alle . . . =For all route segments Sm
370 Delete Sm
380 Memory available?
390 Store segments S(Pi)
End

1-7. (canceled)

8. A method for storing map data in a navigation system, comprising:
calculating a driving route between a start point and a destination, using a first level map data stored on a mass storage medium;
selecting, based on at least one criterion, a second level map data that include only road path segments within a defined corridor around the driving route; and
storing the selected second level map data in a memory of the navigation system.

9. The method as recited in claim 8, wherein all first level map data corresponding to at least one of a first defined region around the start point and a second defined region around the destination are automatically included as a part of the second level map data.

10. The method as recited in claim 9, wherein the selection of the second level map data is accomplished on the basis of a utilization probability of road path segments within the corridor.

11. The method as recited in claim 10, wherein the utilization probability is dependent at least on the distance of a particular road path segment from the driving route.

12. The method as recited in claim 11, wherein the utilization probability is further dependent on a road-class property of the particular road path segment within the corridor.

13. The method as recited in claim 10, wherein the second level map data are organized in tiles corresponding to geographic areas, and wherein the selection of the second level map data for a particular geographic area tile includes screening all first level map data within the particular geographic area tile in accordance with at least one uniform selection criterion.

14. A navigation system, comprising:
a control system for calculating a driving route between a start point and a destination, using a first level map data stored on a mass storage medium, wherein the control system selects, based on at least one criterion, a second level map data that include only road path segments within a defined corridor around the driving route; and
a memory for storing the selected second level map data.

15. The navigation system as recited in claim 14, wherein all first level map data corresponding to at least one of a first defined region around the start point and a second defined region around the destination are automatically included by the control system as a part of the second level map data.

16. The navigation system as recited in claim 15, wherein the selection of the second level map data is accomplished on the basis of a utilization probability of road path segments within the corridor.

17. The navigation system as recited in claim 16, wherein the utilization probability is dependent at least on the distance of a particular road path segment from the driving route.

18. The navigation system as recited in claim 17, wherein the utilization probability is further dependent on a road-class property of the particular road path segment within the corridor.
